(19) United States
(12) Patent Application Publication
(10) Pub. No.: US 2024/0206621 A1
(43) Pub. Date: Jun. 27, 2024

(54) Mascara brush

(71) Applicant: SHYA HSIN PACKAGING INDUSTRY (CHINA) CO., LTD., Kunshan (CN)

(72) Inventor: Fuhai YU, Kunshan (CN)

(73) Assignee: SHYA HSIN PACKAGING INDUSTRY (CHINA) CO., LTD., Kunshan (CN)

(21) Appl. No.: 18/222,498

(22) Filed: Jul. 17, 2023

(30) Foreign Application Priority Data
Dec. 27, 2022 (CN) 202223493295.X

(51) Int. Cl. A46B 9/02; A45D 34/04

(52) U.S. Cl. CPC A46B 9/021; A45D 34/042; A46B 9/026; A46B 2200/1053

(57) ABSTRACT

A mascara brush includes a brush rod and brush bristles. The brush rod includes a holding part and a mounting part that are fixedly connected. Roots of the brush bristles are arranged on a side wall of the mounting part, and free ends of the brush bristles are far from the mounting part. The side wall of the mounting part includes a flat surface, and the flat surface is provided with at least one row of the brush bristles. The center lines of the brush bristles are not perpendicularly intersected with the axis of the brush rod. In the mascara brush, the brush bristles are arranged on the flat surface. The flat surface has better material hanging and retaining ability than an arc surface. The mascara brush can dip and retain more makeup materials from a bottle each time, thereby reducing the times of the mascara brush taking materials.

### CROSS REFERENCE TO THE RELATED APPLICATIONS

This application is based upon and claims priority to Chinese Patent Application No. 202223493295.X, filed on Dec. 27, 2022, the entire contents of which are incorporated herein by reference.

### TECHNICAL FIELD

The present disclosure relates to a cosmetic tool, specifically to a mascara brush with a large material hanging function.

### BACKGROUND

Mascara is a cosmetic product applied to the eyelashes to make them thick, long, curly, and dark in color. Usually, mascara is applied on the eyelashes with a mascara brush. The mascara brush includes a brush rod and brush bristles arranged on the brush rod. At present, the commonly used mascara brush has linear bristles and a cylindrical brush rod. But the material hanging effect of the mascara brush is poor, and the amount of material taken in a single time is small. When applying makeup, material needs to be taken several times, which is inconvenient to use and results in low makeup application efficiency.

### SUMMARY

In view of the above defects, the present disclosure provides a mascara brush. In the mascara brush, brush bristles are arranged on a flat surface. The flat surface has better material hanging and retaining ability than an arc surface. Therefore, the mascara brush is capable of dipping and retaining more makeup materials from a bottle each time, thereby reducing the times of the mascara brush taking materials.

To solve the technical problem, the present disclosure adopts the following technical solutions:

A mascara brush includes a brush rod and brush bristles. The brush rod includes a holding part and a mounting part that are fixedly connected. Roots of the brush bristles are arranged on a side wall of the mounting part, and free ends of the brush bristles are far from the mounting part. The side wall of the mounting part includes a flat surface, and the flat surface is provided with at least one row of the brush bristles. The center lines of the brush bristles are not perpendicularly intersected with the axis of the brush rod.

Optionally, the side wall of the mounting part includes the flat surface and an arc surface, the number of the flat surface is 1 to 20, and all the flat surfaces are provided with the brush bristles.

Optionally, all the flat surfaces are continuously arranged along the circumferential direction of the mounting part, the number of the flat surfaces is 4-16, and the number of the arc surface is 1.

Optionally, the flat surfaces and the arc surfaces are sequentially arranged at intervals along the circumferential direction of the mounting part, the number of the flat surfaces is 2-8, and the number of the arc surfaces is 2-8.

Optionally, the side wall arranged in the circumferential direction of the mounting part is formed by 3-20 of the flat surfaces.

Optionally, the cross-section of the mounting part is a regular polygon.

Optionally, the cross-section of the mounting part is a regular octagon, a regular decagon, a regular dodecagon, a regular tetradecagon, or a regular hexadecagon, and each of the flat surfaces is provided with a row of the brush bristles.

Optionally, the flat surface is arranged in the entire axial direction of the side wall of the mounting part.

Optionally, the mounting part is divided into an upper part, a middle part and a lower part along the axial direction, and the upper part, the middle part and the lower part are at least partially cylindrical structures.

Optionally, the center lines of the brush bristles are arc lines, and all angles between the brush bristles and the axis of the brush rod are identical. The brush bristles are arranged at intervals in a single row along the axis of the brush rod. Alternatively, the brush bristles are arranged at intervals in multiple rows along the axis of the brush rod and arranged at intervals in a cyclone shape along the circumferential direction of the brush rod, and the brush bristles in adjacent rows are juxtaposed with each other or interleaved with each other along the axis of the brush rod.

The advantages of the present disclosure is as follows: the mascara brush of the present disclosure includes a brush rod and brush bristles. The brush rod includes a holding part and a mounting part that are fixedly connected. A side wall of the mounting part includes a flat surface, and the flat surface is provided with at least one row of the brush bristles, Center lines of the brush bristles are not perpendicularly intersected with the axis of the brush rod. Therefore, in the present disclosure, the brush bristles are obliquely arranged on the brush rod, or the center lines of the brush bristles are arc lines, which increases the surface area of the brush bristles. The at least one row of the brush bristles are attached to the flat surface, and the flat surface has better material hanging and retaining ability than an arc surface, so that the mascara brush is configured to dip more makeup materials from the bottle each time, which improves the overall material retaining ability of the mascara brush. In this way, the times of the mascara brush taking materials are reduced and the efficiency of makeup is improved.

### BRIEF DESCRIPTION OF THE DRAWINGS

FIG. 1 is a perspective view of the structure of the present disclosure.

FIG. 2 is a front view of the structure of the present disclosure.

FIG. 3 is a rear view of the structure of the present disclosure.

FIG. 4 is a left view of the structure of the present disclosure.

FIG. 5 is a right view of the structure of the present disclosure.

FIG. 6 is a top view of the structure of the present disclosure.

FIG. 7 is an upward view of the structure of the present disclosure.

FIG. 8 is a schematic diagram showing a longitudinal section of the structure of the present disclosure.

FIG. 9 is a schematic diagram showing a cross-section of the structure of the present disclosure.

In the figures: 10-brush rod, 11-holding part, 12-mounting part, 20-brush bristles.

### DETAILED DESCRIPTION OF THE EMBODIMENTS

The following clearly and completely describes the technical solutions in the embodiments of the present disclosure by referring to the embodiments of the present disclosure. The described embodiments are merely a part, rather than all, of the embodiments of the present disclosure. All other embodiments obtained by those of ordinary skill in the art based on the embodiments of the present disclosure without creative efforts shall fall within the protection scope of the present disclosure.

It should be noted that the terms “first”, “second”, and so on in the description and claims of the present disclosure and the above accompanying drawings are intended to distinguish between similar objects but do not necessarily indicate a specific order or sequence. It should be understood that the data used in such a way may be exchanged under proper conditions to make it possible to implement the described implementations of the present disclosure in other order besides those illustrated or described herein. Moreover, the terms “include”, “contain”, and any other variants mean to cover the non-exclusive inclusion, for example, a process, method, system, product, or device that includes a list of steps or units is not necessarily limited to those steps or units which are listed but may include other steps or units which are not expressly listed or inherent to such a process, method, system, product, or device.

For ease of description, spatially relative terms, such as “above”, “on the upper side of”, “on the upper surface of”, and “on”, can be used to describe the spatial positional relationship between components or features shown in the figure. It should be understood that the spatially relative terms are intended to encompass different orientations of the components in use or operation in addition to those shown in the figure. For example, if a component in the figure is inverted, a component “above other component or structure” or “on other component or structure” will be positioned as “below other component or structure” or “under other component or structure”. Therefore, the exemplary term “above” may include both orientations “above” and “below”. The component may also be positioned in other different ways rotated by 90 degrees or in other orientations, but the relative space description should be explained accordingly.

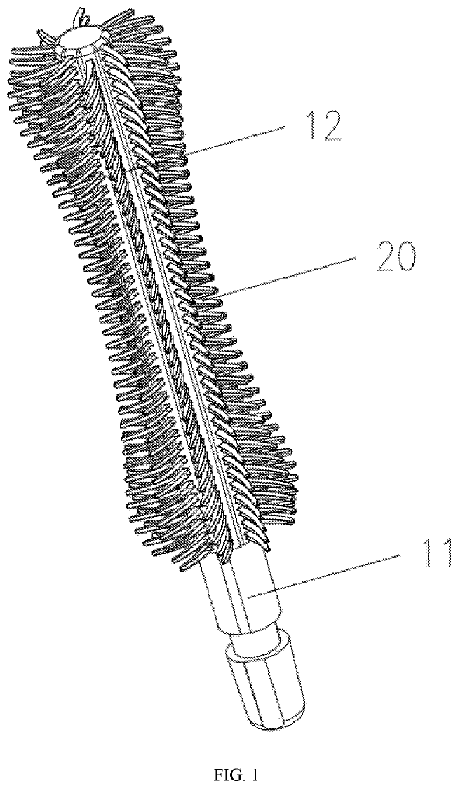

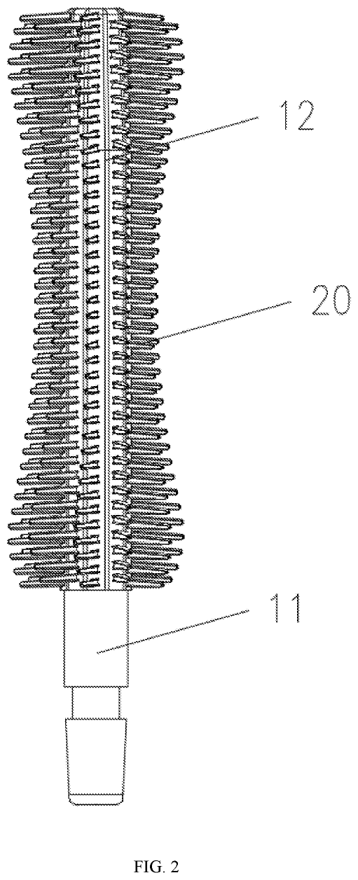

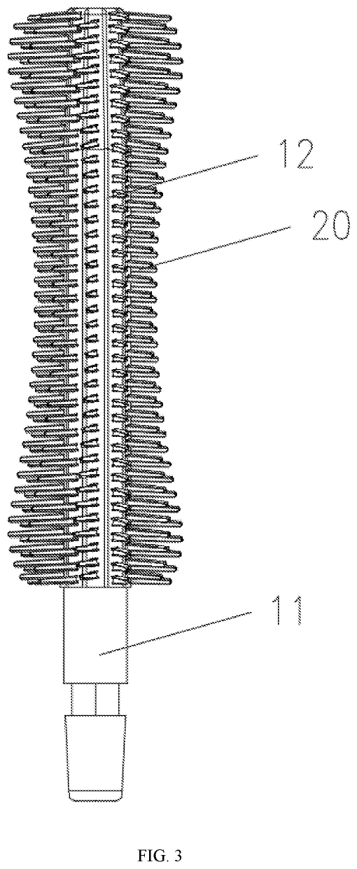

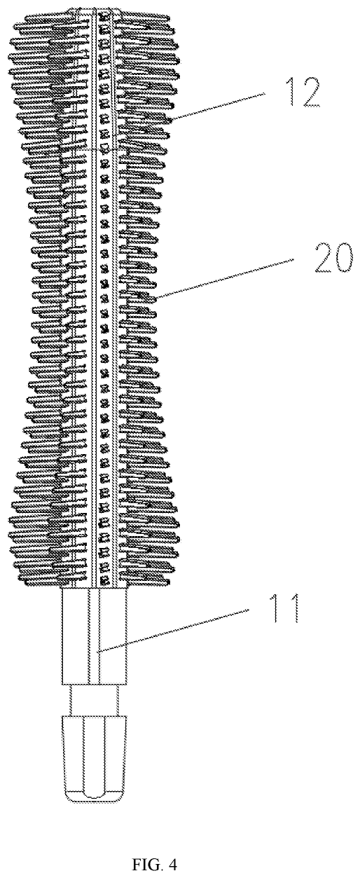

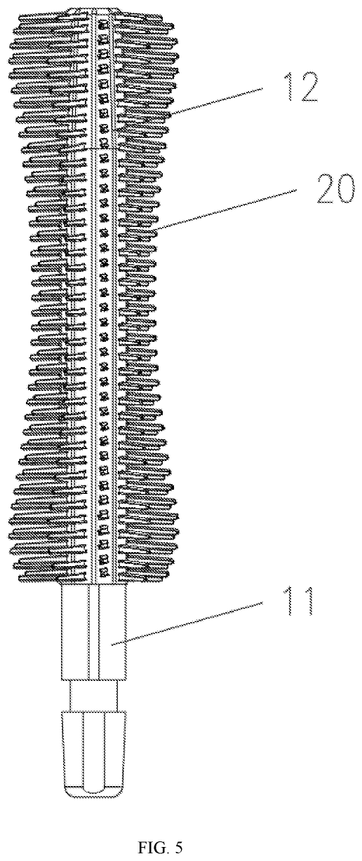

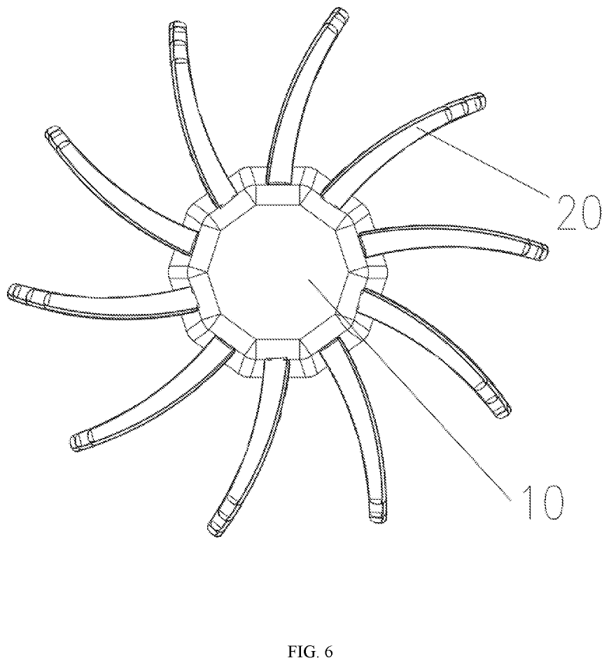

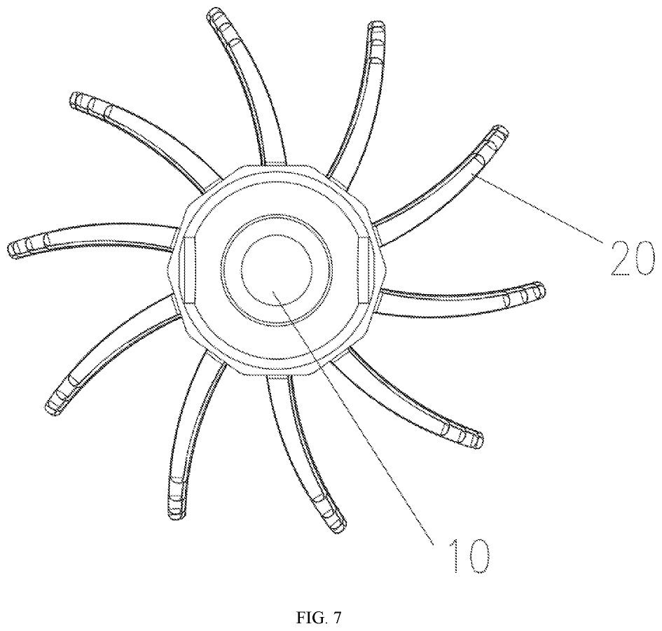

Embodiment: As shown in FIGS. 1-9, a mascara brush includes a brush rod 10 and brush bristles 20. The brush rod 10 includes a holding part 11 and a mounting part 12 that are fixedly connected. Roots of the brush bristles 20 are arranged on a side wall of the mounting part 12, and free ends of the brush bristles 20 are far from the mounting part 12. The side wall of the mounting part 12 includes a flat surface, and the flat surface is provided with at least one row of the brush bristles 20. The center lines of the brush bristles 20 are not perpendicularly intersected with the axis of the brush rod 10. The manufacturing process of the mascara brush includes an integrated molding process, such as an injection molding, glue injection, or blow molding within a molding cycle. Optionally, the brush rod 10 and the brush bristles 20 are integrated injection molded parts. Moreover, the mascara brush can also be manufactured by other processes, which is not limited in the present disclosure. The side wall of the mounting part 12 includes the flat surface, and the flat surface is provided with at least one row of the brush bristles 20, which means that: roots of the at least one row of the brush bristles 20 are attached to the flat surface. The center lines of the brush bristles 20 are not perpendicularly intersected with the axis of the brush rod 10, which means that: the brush bristles 20 are obliquely arranged on the brush rod 10, or the center lines of the brush bristles 20 are arc lines. In the present disclosure, the brush bristles are obliquely arranged on the brush rod, or the center lines of the brush bristles are arc lines, which increases the surface area of the brush bristles. The at least one row of the brush bristles are attached to the flat surface, and the flat surface has better material hanging and retaining ability than an arc surface, so that the mascara brush is configured to dip more makeup materials from the bottle each time, which improves the overall material retaining ability of the mascara brush. In this way, the times of the mascara brush taking materials are reduced and the efficiency of makeup is improved.

In addition, the center lines of the brush bristles 20 are not perpendicularly intersected with the axis of the brush rod 10, that is, an angle is arranged between the center lines of the brush bristles 20 and the axis of the brush rod 10, which makes the brush bristles easily inserted between the eyelashes. Moreover, since the brush bristles are not perpendicular to the axis of the brush rod, the cross-sectional area of the whole mascara brush is reduced, and the mouth of the mascara bottle is correspondingly reduced when the length of the brush bristles is not changed. The mascara brush has the advantages of good applying effect, more compact overall structure, and being easier to comb the eyelashes.

Optionally, the side wall of the mounting part 12 is formed by the flat surface or formed by the flat surface and a non-flat surface. Optionally, the side wall of the mounting part 12 includes the flat surface and an arc surface. The number of the flat surfaces is 1 to 20, and all the flat surfaces are provided with the brush bristles 20. The arc surface can be provided with the brush bristles 20 or without the brush bristles 20.

Optionally, all the flat surfaces are continuously arranged along the circumferential direction of the mounting part 12. The number of the flat surfaces is 4-16, and the number of the arc surface is 1. That is, the cross-section of the mounting part 12 in the radial direction is formed by an arc and a polygon, and the cross-section involved in the present disclosure is perpendicular to the axis of the brush rod 10.

Optionally, the flat surfaces and the arc surfaces are sequentially arranged at intervals along the circumferential direction of the mounting part 12. The number of the flat surfaces is 2-8, and the number of the arc surfaces is 2-8. That is, the side wall of the mounting part 12 is formed by the flat surfaces and the arc surfaces at intervals, and the cross-section of the mounting part 12 in the radial direction is formed by arc lines and straight lines at intervals that are connected to each other. The arc surface can be a convex surface or a concave surface. Optionally, the arc surface is the convex surface, and each arc surface is provided with the brush bristles 20, so it is more convenient to make up when the arc surface is the convex surface. When the arc surface is the concave surface, the material retaining ability is strengthened.

The side wall arranged in the circumferential direction of the mounting part 12 is formed by 3-20 of the flat surfaces. That is, the side wall around the mounting part 12 is formed by all the flat surfaces, and the cross-section of the mounting part 12 is the polygon, where the polygon can be a regular polygon or an irregular polygon.

Optionally, the cross-section of the mounting part 12 is the regular polygon, and the regular polygon has 3-20 sides.

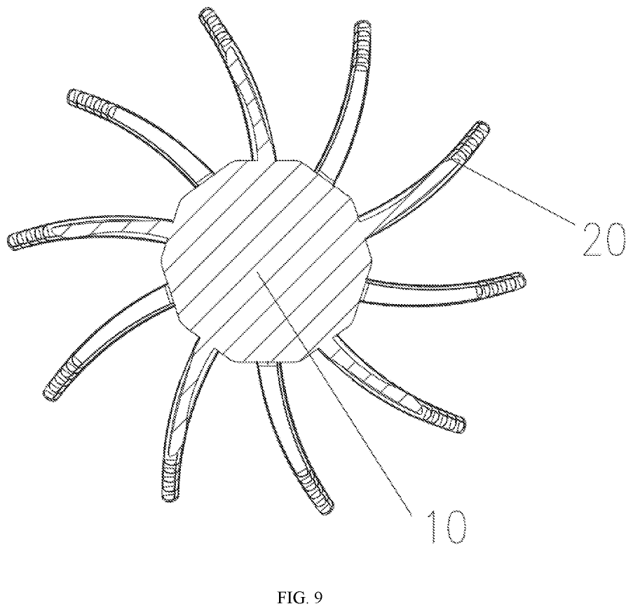

Optionally, the cross-section of the mounting part 12 is a regular octagon, a regular decagon, a regular dodecagon, a regular tetradecagon, or a regular hexadecagon, and each of the flat surfaces is provided with a row of the brush bristles 20. FIG. 9 is a cross-sectional view of the mascara brush of this embodiment. In this embodiment, the cross-section is the regular decagon, that is, the mounting part 12 is formed by ten flat surfaces, and each of the flat surfaces is provided with a row of brush bristles, and the flat surface has a stronger ability to hang and retain materials than the arc surface. Therefore, the mascara brush with this structure has greater material hanging and retention ability. Moreover, the cross-section of the mounting part 12 can also be set to the regular octagon, the regular dodecagon, the regular tetradecagon, and the like. When the number of sides of the cross-section is small, two rows of the brush bristles can be arranged on the flat surface, and the number of sides of the regular polygon should not be too many. When the number of sides of the regular polygon is too many, for example, the number of sides of the regular polygon exceeds 18 sides, the area of the flat surface is too small and loses the advantage of hanging ability. In practice, the number of sides of the regular polygon should be arranged reasonably according to the diameter of the mounting part 12.

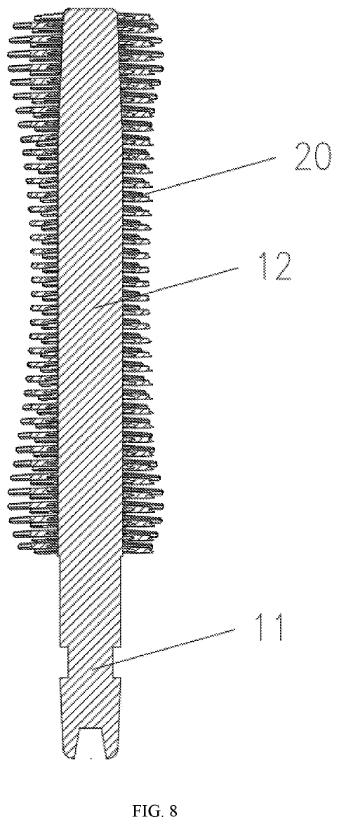

As shown in FIGS. 1-5, the flat surface is arranged in the entire axial direction of the side wall of the mounting part 12. FIG. 1 shows a perspective view of the mascara brush, and FIG. 8 shows a longitudinal section of the mascara brush. From the figures, it can be seen that the flat surface extends from the top of the mounting part 12 to the tail of the mounting part 12, and the tail of the mounting part 12 is connected to the holding part 11. As shown in FIGS. 1 and 9, in this embodiment, the flat surfaces are formed in the entire circumferential direction and axial direction of the mounting part 12.

As shown in FIG. 8, the mounting part 12 is divided into an upper part, a middle part and a lower part along the axial direction, and the upper part, the middle part and the lower part are at least partially cylindrical structures. That is, the mounting part 12 is divided into three segments along the axial direction, namely the upper part, the middle part, and the lower part, respectively. The flat surface of the side wall of the mounting part 12 is arranged in one or two of the three segments, but does not extend the entire axial direction of the mounting part 12. Optionally, the middle part and the lower part are cylindrical structures, that is, the upper part of the mounting part 12 includes the flat surface. Alternatively, the lower part is a cylindrical structure, that is, both the upper part and the middle part of the mounting part 12 include the flat surface. The length of the brush bristles on the middle part of the mounting part 12 is less than the length of the brush bristles on the upper part and the length of the brush bristles on the lower part, so that the mascara brush can be better fitted with the shape of the eyelashes to achieve a better combing effect.

Optionally, the center lines of the brush bristles 20 are arc lines, and all angles between the brush bristles 20 and the axis of the brush rod 10 are identical. The brush bristles 20 are in a single row and arranged at intervals along the axis of the brush rod 10. Alternatively, the brush bristles 20 are arranged at intervals in multiple rows along the axis of the brush rod 10 and arranged at intervals in a cyclone shape along the circumferential direction of the brush rod 10, and the brush bristles 20 in adjacent rows are juxtaposed with each other or interleaved with each other along the axis of the brush rod 10. When the brush bristles 20 are in the multiple rows, the number of rows of the brush bristles 20 is 8, 10, 12, and the like. It should be noted that the number of the rows of the brush bristles 20 described above is exemplary, and the specific number of the rows is not limited in the present disclosure. In this embodiment, the number of 10 rows is described. The brush bristles 20 in the adjacent rows are juxtaposed with each other or interleaved with each other along the axis of the brush rod 10, and the combing effect is improved by interleaving between the two adjacent rows of the brush bristles 20.

It should be noted that those of ordinary skill in the art can further make several variations and improvements without departing from the concept of the present disclosure, and all of these fall within the protection scope of the present disclosure. Therefore, the protection scope of the present disclosure shall be subject to the protection scope defined by the claims.

What is claimed is:

1. A mascara brush, comprising a brush rod and brush bristles, wherein the brush rod comprises a holding part and a mounting part, wherein the holding part and the mounting part are fixedly connected; roots of the brush bristles are arranged on a side wall of the mounting part, and free ends of the brush bristles are far from the mounting part; the side wall of the mounting part comprises a flat surface, and the flat surface is provided with at least one row of the brush bristles; and center lines of the brush bristles are not perpendicularly intersected with an axis of the brush rod.

2. The mascara brush according to claim 1, wherein the side wall of the mounting part comprises the flat surface and an arc surface, wherein a number of the flat surface is 1 to 20, and all the flat surfaces are provided with the brush bristles.

3. The mascara brush according to claim 2, wherein all the flat surfaces are continuously arranged along a circumferential direction of the mounting part, wherein the number of the flat surfaces is 4-16, and a number of the arc surface is 1.

4. The mascara brush according to claim 2, wherein the flat surfaces and arc surfaces are sequentially arranged at intervals along a circumferential direction of the mounting part, wherein the number of the flat surfaces is 2-8, and the number of the arc surfaces is 2-8.

5. The mascara brush according to claim 1, wherein the side wall arranged in the circumferential direction of the mounting part is formed by 3-20 of the flat surfaces.

6. The mascara brush according to claim 5, wherein a cross-section of the mounting part is a regular polygon.

7. The mascara brush according to claim 6, wherein the cross-section of the mounting part is a regular octagon, a regular decagon, a regular dodecagon, a regular tetradecagon, or a regular hexadecagon, and each of the flat surfaces is provided with a row of the brush bristles.

8. The mascara brush according to claim 1, wherein the flat surface is arranged in an entire axial direction of the side wall of the mounting part.

9. The mascara brush according to claim 1, wherein the mounting part is divided into an upper part, a middle part and a lower part along an axial direction, and the upper part, the middle part and the lower part are at least partially cylindrical structures.

10. The mascara brush according to claim 1, wherein center lines of the brush bristles are arc lines, and all angles between the brush bristles and the axis of the brush rod are identical; the brush bristles are arranged at intervals in a single row along the axis of the brush rod; alternatively, the brush bristles are arranged at intervals in multiple rows along the axis of the brush rod and arranged at intervals in a cyclone shape along a circumferential direction of the brush rod, wherein the brush bristles in adjacent rows are juxtaposed with each other, or the brush bristles in adjacent rows are interleaved with each other along the axis of the brush rod.

11. The mascara brush according to claim 2, wherein the flat surface is arranged in an entire axial direction of the side wall of the mounting part.

12. The mascara brush according to claim 3, wherein the flat surface is arranged in an entire axial direction of the side wall of the mounting part.

13. The mascara brush according to claim 4, wherein the flat surface is arranged in an entire axial direction of the side wall of the mounting part.

14. The mascara brush according to claim 5, wherein the flat surface is arranged in an entire axial direction of the side wall of the mounting part.

15. The mascara brush according to claim 6, wherein the flat surface is arranged in an entire axial direction of the side wall of the mounting part.

16. The mascara brush according to claim 7, wherein the flat surface is arranged in an entire axial direction of the side wall of the mounting part.

17. The mascara brush according to claim 2, wherein the mounting part is divided into an upper part, a middle part and a lower part along an axial direction, and the upper part, the middle part and the lower part are at least partially cylindrical structures.

18. The mascara brush according to claim 3, wherein the mounting part is divided into an upper part, a middle part and a lower part along an axial direction, and the upper part, the middle part and the lower part are at least partially cylindrical structures.

19. The mascara brush according to claim 4, wherein the mounting part is divided into an upper part, a middle part and a lower part along an axial direction, and the upper part, the middle part and the lower part are at least partially cylindrical structures.

20. The mascara brush according to claim 5, wherein the mounting part is divided into an upper part, a middle part and a lower part along an axial direction, and the upper part, the middle part and the lower part are at least partially cylindrical structures.
